(19) United States
(12) Patent Application Publication
(10) Pub. No.: US 2018/0254453 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventors: Chikae YOSHIMARU, Osaka-shi (JP); Syusaku HARA, Niihama-shi (JP); Chikara MURAKAMI, Osaka-shi (JP)

(21) Appl. No.: 15/910,215

(22) Filed: Mar. 2, 2018

(30) Foreign Application Priority Data
Mar. 3, 2017 (JP) 2017-041082

(51) Int. Cl. H01M 2/16; H01M 2/14

(52) U.S. Cl. CPC H01M 2/1653; H01M 10/0525; H01M 2/145; H01M 2/1686

(57) ABSTRACT

As a nonaqueous electrolyte secondary battery separator that is excellent in initial battery resistance characteristic of a nonaqueous electrolyte secondary battery including the nonaqueous electrolyte secondary battery separator, provided is a nonaqueous electrolyte secondary battery separator including: a polyolefin porous film, the polyolefin porous film having an internal fractal dimension of 1.75 to 1.91, the internal fractal dimension being measured, by a box counting method, in accordance with a continuous image of the polyolefin porous film which continuous image is formed so as to extend from a surface of the polyolefin porous film in an internal thickness direction of the polyolefin porous film, and in which continuous image a void part and a resin part of the polyolefin porous film are shown at respective two gray levels.

This Nonprovisional application claims priority under 35 U.S.C. § 119 on Patent Application No. 2017-041082 filed in Japan on Mar. 3, 2017, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”).

### BACKGROUND ART

Nonaqueous electrolyte secondary batteries such as a lithium secondary battery are currently in wide use as batteries for devices such as a personal computer, a mobile telephone, and a portable information terminal.

A device provided with a lithium ion battery includes a wide variety of electrical protection circuits, provided in a battery charger or a battery pack, so that the battery operates normally and safely. However, for example, in a case where a breakdown or a malfunction occurs in the protection circuits, the lithium ion battery is continuously recharged. This may cause (i) oxidative and reductive degradation of an electrolyte on surfaces of a positive electrode and a negative electrode both of which generate heat, (ii) oxygen release caused by decomposition of a positive electrode active material, and (iii) deposition of metallic lithium on the negative electrode. This may eventually cause the lithium ion battery to fall into a thermal runaway, so that the lithium ion battery may ignite or explode depending on circumstances.

In order to safely stop a battery before the battery falls into such a dangerous thermal runaway, most lithium ion batteries each currently include, as a separator, a polyolefin porous base material which has a shutdown function of clogging pores in the porous base material in a case where a temperature inside the battery rises due to some trouble in the battery and reaches approximately 130° C. to 140° C. In a case where the shutdown function is carried out at a temperature rise inside the battery, ions can be prevented from passing through the separator, so that the battery can be safely stopped.

Known examples of the polyolefin porous base material include a polyolefin porous base material disclosed in Patent Literature 1.

### CITATION LIST

### Patent Literature

[Patent Literature 1]

Japanese Patent Application Publication, Tokukaihei, No. 11-130900 (Publication Date: May 18, 1999)

### SUMMARY OF INVENTION

### Technical Problem

Note, however, that a nonaqueous electrolyte secondary battery including such a conventional nonaqueous electrolyte secondary battery separator as disclosed in Patent Literature 1 is insufficient in excellence in initial battery resistance.

### Solution to Problem

Under the circumstances, the inventors of the present invention focused on a “fractal dimension”, which serves as an index of complexity of a boundary between different regions, and used the “fractal dimension” to quantify complexity of a structure of an interface between a void part and a resin part (porous film part) of an inside of a porous base material. Then, the inventors of the present invention attained the present invention by finding that a nonaqueous electrolyte secondary battery including, as separator, a polyolefin porous film whose “fractal dimension” falls within a specific range is excellent in initial battery resistance characteristic and useful as a nonaqueous electrolyte secondary battery separator.

An aspect of the present invention includes the following [1] through [5]:

[1] A nonaqueous electrolyte secondary battery separator including: a polyolefin porous film,

the polyolefin porous film having an internal fractal dimension of 1.75 to 1.91, the internal fractal dimension being measured, by a box counting method, in accordance with a continuous image of the polyolefin porous film which continuous image is obtained by FIB-SEM measurement at a magnification of 6500 times and by image analysis, in which continuous image the polyolefin porous film has (i) a size of 256 pix×256 pix in a surface direction thereof and (ii) a thickness corresponding to a thickness of the polyolefin porous film, where 1 pix is 19.2 nm, which continuous image is formed so as to extend from a surface of the polyolefin porous film in an internal thickness direction of the polyolefin porous film, and in which continuous image a void part and a resin part of the polyolefin porous film are shown at respective two gray levels.

[2] The nonaqueous electrolyte secondary battery separator mentioned in [1], wherein the internal fractal dimension is 1.77 to 1.90.
[3] A nonaqueous electrolyte secondary battery laminated separator including: a nonaqueous electrolyte secondary battery separator mentioned in [1] or [2]; and an insulating porous layer.
[4] A nonaqueous electrolyte secondary battery member including: a positive electrode; a nonaqueous electrolyte secondary battery separator mentioned in [1] or [2], or a nonaqueous electrolyte secondary battery laminated separator mentioned in [3]; and a negative electrode, the positive electrode, the nonaqueous electrolyte secondary battery separator or the nonaqueous electrolyte secondary battery laminated separator, and the negative electrode being provided in this order.
[5] A nonaqueous electrolyte secondary battery including: a nonaqueous electrolyte secondary battery separator mentioned in [1] or [2], or a nonaqueous electrolyte secondary battery laminated separator mentioned in [3].

### Advantageous Effects of Invention

A nonaqueous electrolyte secondary battery separator in accordance with an embodiment of the present invention makes it possible to obtain a nonaqueous electrolyte secondary battery including the nonaqueous electrolyte secondary battery separator and having a low initial battery resistance.

### BRIEF DESCRIPTION OF DRAWINGS

FIG. 1 schematically illustrates a step of obtaining an X-Z cross section continuous image from a sample for measurement (hereinafter referred to as a “measurement sample”), the step being a step of a method of calculating an internal fractal dimension of a nonaqueous electrolyte secondary battery separator of an embodiment of the present invention.

FIG. 2 schematically illustrates a step of obtaining a continuous image for analysis (hereinafter referred to as an “analysis continuous image”) from an X-Y plane continuous image shown at two gray levels, the step being a step of a method of calculating an internal fractal dimension of a nonaqueous electrolyte secondary battery separator of an embodiment of the present invention.

FIG. 3 schematically illustrates a step of segmenting an analysis continuous image into a plurality of images each having a size of 1 pix in a Z direction, the step being a step of a method of calculating an internal fractal dimension of a nonaqueous electrolyte secondary battery separator of an embodiment of the present invention.

### DESCRIPTION OF EMBODIMENTS

The following description will discuss an embodiment of the present invention. The present invention is, however, not limited to the embodiment below. The present invention is not limited to the arrangements described below, but may be altered in various ways by a skilled person within the scope of the claims. Any embodiment based on a proper combination of technical means disclosed in different embodiments is also encompassed in the technical scope of the present invention. Note that numerical expressions such as “A to B” herein mean “not less than A and not more than B” unless otherwise stated.

### Embodiment 1: Nonaqueous Electrolyte Secondary Battery Separator

A nonaqueous electrolyte secondary battery separator in accordance with Embodiment 1 of the present invention is a nonaqueous electrolyte secondary battery separator including: a polyolefin porous film, the polyolefin porous film having an internal fractal dimension of 1.75 to 1.91, the internal fractal dimension being measured, by a box counting method, in accordance with a continuous image of the polyolefin porous film which continuous image is obtained by FIB-SEM measurement at a magnification of 6500 times and by image analysis, in which continuous image the polyolefin porous film has (i) a size of 256 pix×256 pix in a surface direction thereof and (ii) a thickness corresponding to a thickness of the polyolefin porous film, where 1 pix is 19.2 nm, which continuous image is formed so as to extend from a surface of the polyolefin porous film in an internal thickness direction of the polyolefin porous film, and in which continuous image a void part and a resin part of the polyolefin porous film are shown at respective two gray levels.

The internal fractal dimension is preferably 1.77 to 1.90, and more preferably 1.80 to 1.89.

A nonaqueous electrolyte secondary battery separator in accordance with an embodiment of the present invention includes a polyolefin porous film, and is preferably made of a polyolefin porous film. Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the whole of materials of which the porous film is made.

The porous film can be a base material of a nonaqueous electrolyte secondary battery separator in accordance with an embodiment of the present invention or a base material of a laminated separator for a nonaqueous electrolyte secondary battery (hereinafter referred to as a “nonaqueous electrolyte secondary battery laminated separator”) in accordance with an embodiment of the present invention, which nonaqueous electrolyte secondary battery laminated separator will be described later. The porous film, which has therein many pores connected to one another, allows a gas and a liquid to pass therethrough from one surface to the other surface thereof.

The polyolefin-based resin more preferably contains a high molecular weight component having a weight-average molecular weight of 3×10⁵ to 15×10⁶. In particular, the polyolefin-based resin which contains a high molecular weight component having a weight-average molecular weight of not less than 1,000,000 is more preferable. This is because such a polyolefin-based resin allows the porous film and a nonaqueous electrolyte secondary battery laminated separator including the porous film to have a higher strength.

The polyolefin-based resin which the porous film contains as a main component is exemplified by but not particularly limited to a homopolymer (e.g., polyethylene, polypropylene, polybutene) and a copolymer (e.g., an ethylene-propylene copolymer) each of which is a thermoplastic resin and is produced by (co)polymerizing monomer(s) such as ethylene, propylene, 1-butene, 4-methyl-1-pentene, and/or 1-hexene. Among these polyolefin-based resins, polyethylene is more preferable. This is because polyethylene is capable of preventing (shutting down) a flow of an excessively large electric current at a lower temperature. Examples of the polyethylene include low-density polyethylene, high-density polyethylene, linear polyethylene (an ethylene-α-olefin copolymer), and ultra-high molecular weight polyethylene having a weight-average molecular weight of not less than 1,000,000. Among these polyethylenes, high molecular weight polyethylene having a weight-average molecular weight of 300,000 to 1,000,000, or ultra-high molecular weight polyethylene having a weight-average molecular weight of not less than 1,000,000 is still more preferable.

An “internal fractal dimension” of a polyolefin porous film of a nonaqueous electrolyte secondary battery separator in accordance with an embodiment of the present invention is calculated by the following method. The polyolefin porous film is processed by use of a focused ion beam (FIB), and an image pickup is repeatedly carried out by use of a scanning electron microscope (SEM) having a magnification of 6500 times, so that a continuous image of an inside of the polyolefin porous film is obtained. Thereafter, a void part and a resin part of the inside of the polyolefin porous film are shown at respective two gray levels. Further, from the continuous image which is shown at two gray levels, a continuous image is obtained in which the polyolefin porous film has (i) a size of 256 pix×256 pix in a surface direction thereof and (ii) a thickness corresponding to a thickness of the polyolefin porous film, where 1 pix is 19.2 nm, and which is formed so as to extend from a surface of the polyolefin porous film in an internal thickness direction of the polyolefin porous film. The obtained continuous image is segmented into a plurality of images each having a thickness of 1 pix. A fractal dimension of a structure of an interface between the void part and the resin part in each of the images obtained by the segmentation is measured by a box counting method, and an average of fractal dimensions thus measured is calculated. The calculated average of the fractal dimensions is referred to as a fractal dimension of a structure of an interface between the void part and the resin part of the inside of the polyolefin porous film (hereinafter referred to as an “internal fractal dimension”).

Note here that a “surface” can be any surface, e.g., an upper surface or a lower surface, of the polyolefin porous film.

“FIB-SEM measurement” refers to a process in which a sample is processed by use of a focused ion beam (FIB), a cross section of the sample is produced (exposed), and an image (electron microscope photograph) showing a result of observation of the cross section by use of a scanning electron microscope (SEM) is obtained. A resin part refers to a part, different from a void part, of a polyolefin porous film.

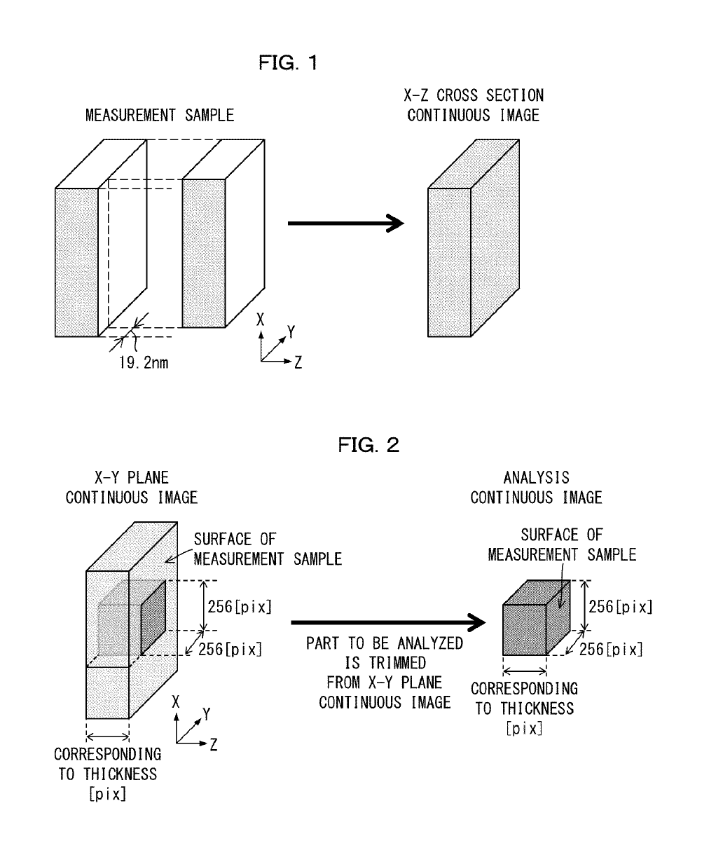

Specifically, an internal fractal dimension of a polyolefin porous film can be measured by, for example, the following method (see FIG. 1 through 3).

First, a polyolefin porous film is impregnated with an embedding resin (e.g., epoxy resin), the embedding resin fills a void part of the polyolefin porous film and then is cured, and the cured embedding resin is treated with osmium tetroxide, so that a measurement sample is produced. On a surface of the measurement sample thus obtained, Pt—Pd is vapor-deposited.

As illustrated in FIG. 1, a thickness direction of the measurement sample (a direction in which a thickness of the measurement sample extends) is a Z direction, any direction that is parallel to a surface of the measurement sample which surface is orthogonal to the thickness is an X direction, and a direction that is orthogonal to each of the X direction and the Z direction is a Y direction. A cross section defined by any side X of a surface of the measurement sample and a thickness Z of the measurement sample (hereinafter referred to as an “X-Z cross section”) is produced by carrying out FIB processing with respect to the measurement sample by use of an FIB-SEM (HELIOS600 manufactured by FEI). The cross section is subjected to SEM observation (in which a reflection electron image is shown) at an acceleration voltage of 2.1 kV and a magnification of 6500 times, so that an SEM image is obtained.

After the SEM observation, FIB processing is carried out with respect to the measurement sample by a thickness of 19.2 nm in the Y direction, which is orthogonal to the X-Z cross section, so that a new X-Z cross section is produced. The new X-Z cross section is subjected to the SEM observation (in which a reflection electron image is shown) under the above conditions, so that an SEM image is obtained. Thereafter, FIB processing and SEM image obtainment are similarly repeated at intervals of a thickness of 19.2 nm, so that an X-Z cross section continuous image of the measurement sample is obtained.

That is, as illustrated in FIG. 1, in a case where X-Z cross sections are repeatedly produced by carrying out FIB processing with respect to the measurement sample at intervals of 19.2 nm along a Y-axis of the measurement sample and each of the X-Z cross sections thus produced is subjected to SEM observation, a continuous X-Z cross section image (X-Z cross section continuous image) of the measurement sample is obtained.

Subsequently, the X-Z cross section continuous image is positionally corrected by use of image analysis software (Avizo Ver.6.0 manufactured by Visualization Sciences Group), and the X-Z cross section continuous image thus corrected is obtained on a scale of 19.2 nm/pix in X, Y, and Z-axes.

Quantitative analysis software (TRI/3D-BON-FCS manufactured by Ratoc System Engineering Co., Ltd.) is used to show the X-Z cross section continuous image, which has been positionally corrected, at two gray levels so that a resin part and a void part of the polyolefin porous film can be distinguished. This allows the resin part and the void part (embedding resin part) to be distinguished.

Subsequently, an X-Z plane of the X-Z cross section continuous image in which the resin part and the void part are shown at respective two gray levels is transformed to an X-Y plane by use of SectionView in an EditViewer mode on the TRI/3D-BON-FCS. This allows the X-Z cross section continuous image to be transformed, on a scale of 19.2 nm/pix in the X, Y, and Z-axes, to a surface direction continuous image (hereinafter referred to as an “X-Y plane continuous image”) of the measurement sample which surface direction continuous image is formed so as to extend from a surface to an inside, i.e., from the surface through the inside to a surface opposite to that surface, of the measurement sample in a thickness direction of the measurement sample, and which surface direction continuous image is shown at two gray levels.

Thereafter, as illustrated in FIG. 2, any part whose number of pixels is 256 pix in the X direction, is 256 pix in the Y direction, and corresponds to a thickness of the measurement sample in the Z direction is trimmed from the X-Y plane continuous image, so that an analysis continuous image is obtained.

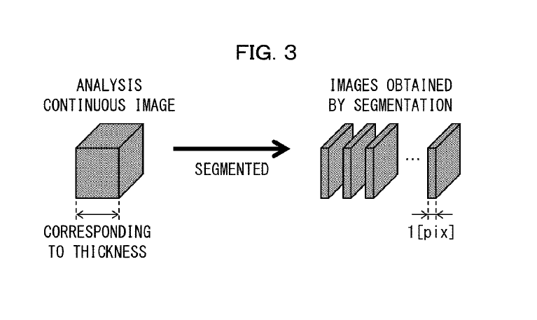

Thereafter, as illustrated in FIG. 3, the analysis continuous image is segmented into a plurality of images each having a size of 1 pix in the Z direction. Each of the plurality of images obtained by the segmentation is stored in a form of a monochrome image in bitmap format and then subjected to fractal dimension analysis carried out by a box counting method, so that a fractal dimension of a structure of an interface between the void part and the resin part in each of the plurality of images obtained by the segmentation is calculated. Further, respective fractal dimensions thus calculated in the plurality of images each having a size of 1 pix in the Z direction are averaged, so that an average obtained is referred to as an “internal fractal dimension” of the polyolefin porous film.

For the above-described analysis carried out by the box counting method, image analysis software PopImaging Ver.6.0 (manufactured by Digital being kids Ltd.) is used. Specifically, the stored monochrome image in bitmap format is viewed by use of the image analysis software (PopImaging Ver.6.0) and subjected to fractal analysis through analysis carried out on a menu of the image analysis software, so that a fractal dimension is calculated.

Note that analysis of a fractal dimension by the box counting method is a publicly known method. Alternatively, a fractal dimension can be analyzed by use of other image analysis software or program that has a function identical to a function of the above-described image analysis software, provided that the other image analysis software or program allows an analysis result to be sufficiently reproducible. Examples of the other image analysis software include image analysis software such as “AT-Image”.

The fractal dimension is an index that quantitatively indicates complexity of a structure of an interface between a void part and a resin part of a polyolefin porous film. Specifically, a fractal dimension per unit area of 1 means a straight line (one dimension), and a fractal dimension per unit area of 2 means a solid plane (two dimension). That is, a fractal dimension that is closer to 2 means that a structure of an interface between a void part and a resin part of a polyolefin porous film is more complex and denser. Meanwhile, a fractal dimension that is closer to 1 means that a structure of an interface between a void part and a resin part of a polyolefin porous film is more simple and sparser.

The polyolefin porous film which has a small internal fractal dimension means that a structure of an interface between a void part and a resin part of the polyolefin porous film is simple and many simple structures, e.g., merely columnar structures are present in the polyolefin porous film. Meanwhile, the polyolefin porous film which has a great internal fractal dimension means that a structure of an interface between a void part and a resin part of the polyolefin porous film is complex and many complex structures each partitioned with an intricate resin part are present in the polyolefin porous film. That is, a smaller internal fractal dimension tends to cause each void to have a larger size and cause a resin part to be thicker. As a result, a smaller internal fractal dimension tends to cause a polyolefin porous film to have lower in-plane uniformity. Meanwhile, a greater internal fractal dimension tends to cause each void to have a smaller size and cause a resin part to be thinner. As a result, a greater internal fractal dimension tends to make a path for ions longer (cause ions to travel a longer distance).

Therefore, in a case where the polyolefin porous film has an internal fractal dimension of not less than 1.75 and a structure of an interface between a void part and a resin part of the polyolefin porous film has complexity whose degree is equal to or higher than a certain degree, the polyolefin porous film (nonaqueous electrolyte secondary battery separator) has high in-plane uniformity. Thus, the polyolefin porous film (nonaqueous electrolyte secondary battery separator) which is used in a battery allows flow of ions (e.g., Li⁺) to be uniform throughout a plane of the polyolefin porous film (nonaqueous electrolyte secondary battery separator). The polyolefin porous film which has a too small internal fractal dimension has low in-plane uniformity. This results in production of a part into which ions concentratedly flow and a part into which ions less easily flow. In the part into which ions concentratedly flow, an electrode excessively operates. Meanwhile, in the part into which ions less easily flow, an electrode does not operate. This causes a variation in operating state in an electrode plane and consequently causes an increase in battery resistance.

Meanwhile, in a case where the polyolefin porous film has an internal fractal dimension of not more than 1.91 and a structure of an interface between a void part and a resin part of the polyolefin porous film has complexity whose degree is equal to or lower than a certain degree, ions can be prevented from traveling a long distance due to too high complexity of the structure. This makes it possible to prevent a deterioration in initial battery resistance characteristic. The polyolefin porous film which has a too great internal fractal dimension is considered to cause ions to travel a long distance due to excessively high complexity of the structure and consequently cause an increase in battery resistance.

That is, in a case where the polyolefin porous film has an internal fractal dimension of not less than 1.75 and not more than 1.91, complexity of a structure of an interface between a void part and a resin part of the polyolefin porous film can be properly controlled, so that a high initial battery resistance characteristic can be achieved.

The polyolefin porous film has a thickness that is not particularly limited but is preferably 4 μm to 40 μm, and more preferably 5 μm to 20 μm.

The polyolefin porous film which has a thickness of not less than 4 μm is preferable from the viewpoint that such a polyolefin porous film makes it possible to sufficiently prevent an internal short circuit from occurring in a battery.

Meanwhile, the polyolefin porous film which has a thickness of not more than 40 μm is preferable from the viewpoint that such a polyolefin porous film makes it possible to sufficiently prevent a nonaqueous electrolyte secondary battery from being larger in size.

The polyolefin porous film ordinarily has a weight per unit area of preferably 4 g/m² to 20 g/m², and more preferably 5 g/m² to 12 g/m² so that a battery has a high weight energy density and a high volume energy density.

The polyolefin porous film has a Gurley air permeability of preferably 30 sec/100 mL to 500 sec/100 mL, and more preferably 50 sec/100 mL to 300 sec/100 mL from the viewpoint that such a polyolefin porous film shows sufficient ion permeability.

The polyolefin porous film has a porosity of preferably 20% by volume to 80% by volume, and more preferably 30% by volume to 75% by volume so that (i) a greater amount of an electrolyte can be retained by the polyolefin porous film and (ii) a function of preventing (shutting down) a flow of an excessively large current at a lower temperature without fail can be achieved.

From the viewpoint that the polyolefin porous film (i) shows sufficient ion permeability and (ii) prevents entry thereinto particles which constitute an electrode, the polyolefin porous film has pores whose diameter is preferably not more than 0.3 μm, and more preferably not more than 0.14 μm.

A nonaqueous electrolyte secondary battery separator in accordance with an embodiment of the present invention can include, as necessary, a porous layer in addition to the polyolefin porous film. Examples of such a porous layer include an insulating porous layer of a nonaqueous electrolyte laminated separator (described later) and other publicly known porous layer(s) such as a heat-resistant layer, an adhesive layer, and/or a protective layer.

[Method of Producing Polyolefin Porous Film]

The polyolefin porous film can be produced by a method that is exemplified by but not particularly limited to a method in which a polyolefin-based resin and an additive are melted and kneaded, and then extruded so as to obtain a polyolefin resin composition, and the polyolefin resin composition is stretched, cleaned, and dried.

Specifically, the polyolefin porous film can be produced by a method including the following steps of:

(A) obtaining a polyolefin resin composition by feeding polyolefin-based resin and an additive into a twin screw kneading extruder, and melting and kneading a resultant mixture in the twin screw kneading extruder;

(B) obtaining a sheet polyolefin resin composition by extruding, through a T-die of an extruder, the polyolefin resin composition which has been obtained in the step (A) and is molten, and then forming the polyolefin resin composition into a sheet while cooling the polyolefin resin composition;

(C) stretching the sheet polyolefin resin composition which has been obtained in the step (B);

(D) cleaning, by use of a cleaning liquid, the polyolefin resin composition which has been stretched in the step (C); and

(E) obtaining a polyolefin porous film by drying and/or heat-fixing the polyolefin resin composition which has been cleaned in the step (D).

In the step (A), the polyolefin-based resin is used in an amount of preferably 5% by weight to 50% by weight, and more preferably 10% by weight to 30% by weight, with respect to 100% by weight of the polyolefin resin composition to be obtained.

Examples of the additive which is used in the step (A) include phthalate esters such as dioctyl phthalate, unsaturated higher alcohols such as oleyl alcohol, saturated higher alcohols such as stearyl alcohol, paraffin wax, a petroleum resin, and liquid paraffin.

Examples of the petroleum resin include (i) aliphatic hydrocarbon resins obtained by polymerizing C5 petroleum fractions, such as isoprene, pentene, and pentadiene, which serve as principal materials of the aliphatic hydrocarbon resins, (ii) aromatic hydrocarbon resins obtained by polymerizing C9 petroleum fractions, such as indene, vinyl toluene, and methyl styrene, which serve as principal materials of the aromatic hydrocarbon resins, (iii) copolymer resins of the resins (i) and (ii), (iv) alicyclic saturated hydrocarbon resins obtained by hydrogenating the resins (i) to (iii), and (v) mixtures of the resins (i) to (iv). The petroleum resin is preferably an alicyclic saturated hydrocarbon resin.

In particular, a pore forming agent such as liquid paraffin is preferably used as the additive.

Further, in particular, in a case where a petroleum resin is used as the additive, complexity of a structure of an interface between a void part and a resin part of a polyolefin porous film to be obtained tends to be more suitably controllable. As a result, an internal fractal dimension of a nonaqueous electrolyte secondary battery separator including the polyolefin porous film can be controlled so as to fall within a suitable range.

In the step (A), the twin screw kneading extruder revolves at preferably not less than 50 rpm and not more than 2,000 rpm, more preferably not less than 100 rpm and not more than 1,000 rpm, and still more preferably not less than 150 rpm and not more than 500 rpm. In a case where the twin screw kneading extruder revolves at not less than 50 rpm, it is possible to prevent a deterioration in uniform dispersibility of the polyolefin-based resin and the additive. As a result, the internal fractal dimension can be made greater and be controlled so as to fall within a suitable range. Meanwhile, in a case where the twin screw kneading extruder revolves at not more than 2,000 rpm, it is possible to reduce (i) shear energy to be applied to the resin and (ii) an increase in generation of heat during the kneading, and consequently to prevent occurrence of thermal degradation (e.g., molecular scission) in the polyolefin-based resin. As a result, the internal fractal dimension can be made smaller and be controlled so as to fall within a suitable range.

From the viewpoint of prevention of thermal degradation, the polyolefin resin composition is preferably controlled so as to have a temperature of not more than 255° C., more preferably not more than 250° C., and still more preferably not more than 245° C., in an outlet part of the twin screw kneading extruder.

In the step (B), the polyolefin resin composition is preferably cooled by, for example, being brought into contact with a cooling roller.

In the step (B), a difference between (a) the temperature of the polyolefin resin composition in the outlet part of the twin screw kneading extruder in the step (A) and (b) a temperature of the cooling roller is controlled so as to be preferably not less than 100° C. and not more than 260° C., more preferably not less than 110° C. and not more than 250° C., and still more preferably not less than 115° C. and not more than 240° C. In a case where the difference in temperature is not less than 100° C., the polyolefin resin composition can be satisfactorily cooled, and it is possible to prevent rough phase separation of the polyolefin-based resin and the additive. As a result, the internal fractal dimension can be made greater and be controlled so as to fall within a suitable range. Meanwhile, in a case where the difference in temperature is not more than 260° C. and the polyolefin resin composition is cooled at a speed that is not made too high and is controlled so as to fall within a suitable range, occurrence of minute microphase separation is prevented. As a result, the internal fractal dimension can be made smaller and be controlled so as to fall within a suitable range.

In the step (C), the sheet polyolefin resin composition can be stretched by use of a commercially-available stretching apparatus. The sheet polyolefin resin composition has a temperature of not more than a melting point of a polyolefin-based resin, preferably not less than 80° C. and not more than 125° C., and more preferably not less than 100° C. and not more than 120° C.

The sheet polyolefin resin composition can be stretched only in an MD direction, only in a TD direction, or both in the MD direction and in the TD direction. Examples of a method in which the sheet polyolefin resin composition is stretched both in the MD direction and in the TD direction include (i) a method in which the sheet polyolefin resin composition is sequentially biaxially stretched, i.e., stretched in the MD direction and subsequently stretched in the TD direction, and (ii) a method in which the sheet polyolefin resin composition is simultaneously biaxially stretched i.e., stretched in the MD direction and in the TD direction simultaneously.

The sheet polyolefin resin composition can be stretched by (i) causing a chuck to hold both sides of the sheet polyolefin resin composition, (ii) changing a rotation speed of a roller on which the sheet polyolefin resin composition is to be transferred, or (iii) using a pair of rollers to roll the sheet polyolefin resin composition.

The following description will specifically discuss a condition under which to sequentially biaxially stretch the sheet polyolefin resin composition in the step (C). The sheet polyolefin resin composition is stretched in the MD direction at a stretch ratio of preferably not less than 3.0 times and not more than 7.0 times, and more preferably not less than 4.5 times and not more than 6.5 times. The sheet polyolefin resin composition is stretched in the TD direction at a stretch ratio of preferably not less than 3.0 times and not more than 7.0 times, and more preferably not less than 4.5 times and not more than 6.5 times.

The cleaning liquid which is used in the step (D) can be any solvent provided that the solvent allows an additive such as a pore forming agent to be removed. Examples of the cleaning liquid include heptane and dichloromethane.

A nonaqueous secondary battery laminated separator in accordance with Embodiment 2 of the present invention includes: a nonaqueous electrolyte secondary battery separator in accordance with Embodiment 1 of the present invention; and an insulating porous layer. Thus, the nonaqueous secondary battery laminated separator in accordance with Embodiment 2 of the present invention includes the polyolefin porous film of the above-described nonaqueous electrolyte secondary battery separator in accordance with Embodiment 1 of the present invention.

[Insulating Porous Layer]

An insulating porous layer of a nonaqueous electrolyte secondary battery laminated separator in accordance with an embodiment of the present invention is ordinarily a resin layer containing a resin, and is preferably a heat-resistant layer or an adhesive layer. The resin of which the insulating porous layer (hereinafter also merely referred to as a “porous layer”) is made is preferably a resin that is insoluble in a nonaqueous electrolyte of a battery and that is electrochemically stable when the battery is in normal use.

The porous layer is disposed on one surface or both surfaces of the nonaqueous electrolyte secondary battery separator as necessary. In a case where the porous layer is disposed on one surface of the polyolefin porous film, the porous layer is disposed preferably on that surface of the polyolefin porous film which surface faces a positive electrode of a nonaqueous electrolyte secondary battery to be produced, more preferably on that surface of the polyolefin porous film which surface is in contact with the positive electrode.

Examples of the resin of which the porous layer is made include polyolefins, (meth)acrylate-based resins, fluorine-containing resins, polyamide-based resins, polyester-based resins, polyimide-based resins, rubbers, and resins whose melting point or glass transition temperature is not less than 180° C., and water-soluble polymers.

Among the above resins, polyolefins, acrylate-based resins, fluorine-containing resins, polyamide-based resins, polyester-based resins, and water-soluble polymers are preferable. As the polyamide-based resins, wholly aromatic polyamides (aramid resins) are preferable. As the polyester-based resins, polyarylates and liquid crystal polyesters are preferable.

The porous layer can contain fine particles. The term “fine particles” herein means organic fine particles or inorganic fine particles generally referred to as a filler. Therefore, in a case where the porous layer contains fine particles, the above resin contained in the porous layer has a function as a binder resin of binding (i) fine particles together and (ii) fine particles and the porous film. The fine particles are preferably insulating fine particles.

Examples of the organic fine particles contained in the porous layer include resin fine particles.

Specific examples of the inorganic fine particles contained in the porous layer include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are insulating fine particles. The porous layer can contain (i) only one kind of the fine particles or (ii) a combination of two or more kinds of the fine particles.

Among the above fine particles, fine particles made of an inorganic matter is suitable. Fine particles made of an inorganic oxide such as silica, calcium oxide, magnesium oxide, titanium oxide, alumina, mica, zeolite, aluminum hydroxide, or boehmite are more preferable. Further, fine particles made of at least one kind selected from the group consisting of silica, magnesium oxide, titanium oxide, aluminum hydroxide, boehmite, and alumina are still more preferable. Fine particles made of alumina are particularly preferable.

The porous layer contains the fine particles at a proportion of preferably 1% by volume to 99% by volume, and more preferably 5% by volume to 95% by volume. The porous layer which contains the fine particles at a proportion falling within the above range makes it less likely for a void, which is formed when fine particles come into contact with each other, to be blocked by a resin or the like. This (i) allows the nonaqueous electrolyte secondary battery laminated separator to achieve sufficient ion permeability and (ii) allows the porous layer to have a proper weight per unit area.

The porous layer can contain a combination of two or more kinds of fine particles which two or more kinds differ from each other in particle and/or specific surface area.

The porous layer has a thickness (per single porous layer) of preferably 0.5 μm to 15 μm, and more preferably 2 μm to 10 μm.

The porous layer which has a thickness of less than 1 μm may make it impossible to sufficiently prevent an internal short circuit caused by, for example, breakage of a battery. The porous layer which has a thickness of less than 1 μm may also cause the porous layer to retain a smaller amount of an electrolyte. Meanwhile, in a case where the porous layer which is disposed on both surfaces of the nonaqueous electrolyte secondary battery separator has a thickness of more than 30 μm in total, a nonaqueous electrolyte secondary battery may deteriorate in rate characteristic or cycle characteristic.

The porous layer has a weight per unit area (per single porous layer) of preferably 1 g/m² to 20 g/m², and more preferably 4 g/m² to 10 g/m².

The volume per square meter of the porous layer constituent component contained in the porous layer (per single porous layer) is preferably 0.5 cm³ to 20 cm³, more preferably 1 cm³ to 10 cm³, and still more preferably 2 cm³ to 7 cm³.

In order for the nonaqueous electrolyte secondary battery laminated separator to achieve sufficient ion permeability, the porous layer has a porosity of preferably 20% by volume to 90% by volume, and more preferably 30% by volume to 80% by volume. In order for the nonaqueous electrolyte secondary battery laminated separator to achieve sufficient ion permeability, the porous layer has pores whose diameter is preferably not more than 3 μm, and more preferably not more than 1 μm.

[Laminate]

A laminate, which is a nonaqueous secondary battery laminated separator in accordance with Embodiment 2 of the present invention, includes: a nonaqueous secondary battery separator in accordance with an embodiment of the present invention; and an insulating porous layer, and is preferably arranged to include: a nonaqueous secondary battery separator in accordance with an embodiment of the present invention; and an insulating porous layer (described earlier) disposed on one surface or both surfaces of the nonaqueous secondary battery separator.

A laminate in accordance with an embodiment of the present invention has a thickness of preferably 5.5 μm to 45 μm, and more preferably 6 μm to 25 μm.

A laminate in accordance with an embodiment of the present invention has a Gurley air permeability of preferably 30 sec/100 mL to 1000 sec/100 mL, and more preferably 50 sec/100 mL to 800 sec/100 mL.

Note that a laminate in accordance with an embodiment of the present invention can include, as necessary, publicly known porous film(s) (porous layer(s)) such as a heat-resistant layer, an adhesive layer, and/or a protective layer in addition to the polyolefin porous film and the insulating porous layer, provided that such porous film(s) (porous layer(s)) does/do not impair an object of the present invention.

A laminate in accordance with an embodiment of the present invention includes, as a base material, a polyolefin porous film that has an internal fractal dimension falling within a specific range. This allows a nonaqueous electrolyte secondary battery that includes the laminate as a nonaqueous electrolyte secondary battery laminated separator to have a lower initial battery resistance.

[Method of Producing Porous Layer and Method of Producing Laminate]

An insulating porous layer in accordance with an embodiment of the present invention and a laminate in accordance with an embodiment of the present invention each can be produced by, for example, depositing an insulating porous layer by coating a surface of a polyolefin porous film of a nonaqueous electrolyte secondary battery separator in accordance with an embodiment of the present invention with a coating liquid (described later) and drying the polyolefin porous film whose surface has been coated with the coating liquid.

Note that a surface of a polyolefin porous film of a nonaqueous electrolyte secondary battery separator in accordance with an embodiment of the present invention which surface is to be coated with a coating liquid can be subjected to a hydrophilization treatment as necessary before being coated with the coating liquid.

A coating liquid that is used for each of a method of producing a porous layer of an embodiment of the present invention and a method of producing a laminate in accordance with an embodiment of the present invention can be ordinarily prepared by dissolving, in a solvent, a resin that may be contained in the porous layer, and dispersing, in the solvent, fine particles that may be contained in the porous layer. Note here that a solvent in which to dissolve a resin also serves as a dispersion medium for dispersing fine particles therein. Note also that the resin can be made in a form of an emulsion by use of the solvent.

The solvent (dispersion medium) is not particularly limited provided that the solvent (dispersion medium) (i) does not adversely affect the polyolefin porous film, (ii) allows the resin to be uniformly and stably dissolved therein, and (iii) allows the fine particles to be uniformly and stably dispersed therein. Specific examples of the solvent (dispersion medium) include water and an organic solvent. It is possible to use only one kind of the above solvents, or to use two or more kinds of the above solvents in combination.

The coating liquid can be prepared by any method provided that the coating liquid can satisfy conditions necessary for obtainment of a desired porous layer, such as a resin solid content (resin concentration) and a fine particle content. Specific examples of the method of preparing the coating liquid include a mechanical stirring method, an ultrasonic dispersion method, a high-pressure dispersion method, and a media dispersion method. The coating liquid can contain additive(s) such as a disperser, a plasticizer, a surfactant, and/or a pH adjusting agent as component(s) in addition to the resin and the fine particles, provided that the coating liquid which contains such additive(s) does not impair the object of the present invention. Note that the additive(s) only need(s) to be added in an amount that does not impair the object of the present invention.

The coating liquid can be applied to the polyolefin porous film, i.e., a porous layer can be formed on a surface of the polyolefin porous film by any method that is not particularly limited. Examples of the method of forming the porous layer include a method in which a surface of a polyolefin porous film is directly coated with a coating liquid, and then a solvent (dispersion medium) is removed; a method in which a suitable support is coated with a coating liquid, a solvent (dispersion medium) is removed so as to form a porous layer, the porous layer and a polyolefin porous film are pressure-bonded, and then the support is peeled off; and a method in which a suitable support is coated with a coating liquid, a polyolefin porous film is pressure-bonded to a surface of the support which surface has been coated with the coating liquid, the support is peeled off, and then a solvent (dispersion medium) is removed.

The coating liquid can be applied to the polyolefin porous film by a conventionally publicly known method that is specifically exemplified by a gravure coater method, a dip coater method, a bar coater method, and a die coater method.

The solvent (dispersion medium) is typically removed by being dried. The solvent (dispersion medium) contained in the coating liquid can be replaced with another solvent before being dried.

### Embodiment 3: Nonaqueous Electrolyte Secondary Battery Member, Embodiment 4: Nonaqueous Electrolyte Secondary Battery

A member for a nonaqueous electrolyte secondary battery (hereinafter referred to as a “nonaqueous electrolyte secondary battery member”) in accordance with Embodiment 3 of the present invention includes: a positive electrode; a nonaqueous electrolyte secondary battery separator in accordance with Embodiment 1 of the present invention or a nonaqueous electrolyte secondary battery laminated separator in accordance with Embodiment 2 of the present invention; and a negative electrode, the positive electrode, the nonaqueous electrolyte secondary battery separator or the nonaqueous electrolyte secondary battery laminated separator, and the negative electrode being provided in this order.

A nonaqueous electrolyte secondary battery in accordance with Embodiment 4 of the present invention includes: a nonaqueous electrolyte secondary battery separator in accordance with Embodiment 1 of the present invention, or a nonaqueous electrolyte secondary battery laminated separator in accordance with Embodiment 2 of the present invention.

A nonaqueous electrolyte secondary battery in accordance with an embodiment of the present invention can be, for example, a nonaqueous secondary battery that achieves an electromotive force through doping and dedoping with lithium, and can include a nonaqueous electrolyte secondary battery member including a positive electrode, a nonaqueous electrolyte secondary battery separator in accordance with an embodiment of the present invention, and a negative electrode, the positive electrode, the nonaqueous electrolyte secondary battery separator, and the negative electrode being disposed in this order. Alternatively, a nonaqueous electrolyte secondary battery in accordance with an embodiment of the present invention can be, for example, a nonaqueous secondary battery that achieves an electromotive force through doping and dedoping with lithium, and can be a lithium ion secondary battery that includes a nonaqueous electrolyte secondary battery member including a positive electrode, a porous layer, a nonaqueous electrolyte secondary battery separator in accordance with an embodiment of the present invention, and a negative electrode, the positive electrode, the porous layer, the nonaqueous electrolyte secondary battery separator, and the negative electrode being disposed in this order, i.e., a lithium ion secondary battery that includes a nonaqueous electrolyte secondary battery member including a positive electrode, a nonaqueous electrolyte secondary battery laminated separator in accordance with an embodiment of the present invention, and a negative electrode, the positive electrode, the nonaqueous electrolyte secondary battery laminated separator, and the negative electrode being disposed in this order. Note that constituent elements, other than the nonaqueous electrolyte secondary battery separator, of the nonaqueous electrolyte secondary battery are not limited to those described below.

A nonaqueous electrolyte secondary battery in accordance with an embodiment of the present invention is ordinarily structured such that a battery element is enclosed in an exterior member, the battery element including a structure in which a negative electrode and a positive electrode face each other via a nonaqueous electrolyte secondary battery separator in accordance with an embodiment of the present invention or a nonaqueous electrolyte secondary battery laminated separator in accordance with an embodiment of the present invention and which is impregnated with a nonaqueous electrolyte. The nonaqueous electrolyte secondary battery is preferably a nonaqueous electrolytic secondary battery, and is particularly preferably a lithium ion secondary battery. Note that the doping means occlusion, support, adsorption, or insertion, and means a phenomenon in which lithium ions enter an active material of an electrode such as a positive electrode.

A nonaqueous electrolyte secondary battery member in accordance with an embodiment of the present invention includes a nonaqueous electrolyte secondary battery separator in accordance with an embodiment of the present invention or a nonaqueous electrolyte secondary battery laminated separator in accordance with an embodiment of the present invention. Thus, the nonaqueous electrolyte secondary battery member which is incorporated in a nonaqueous electrolyte secondary battery makes it possible to prevent an increase in resistance of the nonaqueous electrolyte secondary battery after a cycle of charge and discharge of the nonaqueous electrolyte secondary battery. A nonaqueous electrolyte secondary battery in accordance with an embodiment of the present invention includes a nonaqueous electrolyte secondary battery separator in accordance with an embodiment of the present invention which nonaqueous electrolyte secondary battery separator has an internal fractal dimension that is adjusted so as to fall within a specific range. Thus, the nonaqueous electrolyte secondary battery yields an effect of being excellent in initial battery resistance.

<Positive Electrode>

A positive electrode included in each of a nonaqueous electrolyte secondary battery member in accordance with an embodiment of the present invention and a nonaqueous electrolyte secondary battery in accordance with an embodiment of the present invention is not limited to any particular one, provided that the positive electrode is one that is typically used as a positive electrode of a nonaqueous electrolyte secondary battery. Examples of the positive electrode include a positive electrode sheet having a structure in which an active material layer containing a positive electrode active material and a binder resin is formed on a current collector. Note that the active material layer can further contain an electrically conductive agent and/or a binding agent.

Examples of the positive electrode active material include a material capable of being doped and dedoped with lithium ions. Specific examples of such a material include a lithium complex oxide containing at least one transition metal such as V, Mn, Fe, Co, and Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one kind of the above electrically conductive agents, or to use two or more kinds of the above electrically conductive agents in combination.

Examples of the binding agent include (i) fluorine-based resins such as polyvinylidene fluoride, (ii) acrylic resin, and (iii) styrene butadiene rubber. Note that the binding agent also serves as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include a method in which a positive electrode active material, an electrically conductive agent, and a binding agent are pressure-molded on a positive electrode current collector; and a method in which (i) a positive electrode active material, an electrically conductive agent, and a binding agent are formed into a paste by use of a suitable organic solvent, (ii) a positive electrode current collector is coated with the paste, and (iii) the paste is dried and then pressured so as to be firmly fixed to the positive electrode current collector.

<Negative Electrode>

A negative electrode included in each of a nonaqueous electrolyte secondary battery member in accordance with an embodiment of the present invention and a nonaqueous electrolyte secondary battery in accordance with an embodiment of the present invention is not limited to any particular one, provided that the negative electrode is one that is typically used as a negative electrode of a nonaqueous electrolyte secondary battery. Examples of the negative electrode include a negative electrode sheet having a structure in which an active material layer containing a negative electrode active material and a binder resin is formed on a current collector. Note that the active material layer can further contain an electrically conductive agent.

Examples of the negative electrode active material include (i) a material capable of being doped and dedoped with lithium ions, (ii) a lithium metal, and (iii) a lithium alloy. Examples of the material include carbonaceous materials. Examples of the carbonaceous materials include natural graphite, artificial graphite, cokes, carbon black, and pyrolytic carbons.

Examples of the negative electrode current collector include electric conductors such as Cu, Ni, and stainless steel. Among these electric conductors, Cu is more preferable because Cu is not easily alloyed with lithium especially in the case of a lithium ion secondary battery and is easily processed into a thin film.

Examples of a method of producing the negative electrode sheet include a method in which a negative electrode active material is pressure-molded on a negative electrode current collector; and a method in which (i) a negative electrode active material is formed into a paste by use of a suitable organic solvent, (ii) a negative electrode current collector is coated with the paste, and (iii) the paste is dried and then pressured so as to be firmly fixed to the negative electrode current collector. The paste preferably contains the electrically conductive agent and the binding agent.

<Nonaqueous Electrolyte>

A nonaqueous electrolyte of a nonaqueous electrolyte secondary battery in accordance with an embodiment of the present invention is not limited to any particular one, provided that the nonaqueous electrolyte is one that is typically used as a nonaqueous electrolyte of a nonaqueous electrolyte secondary battery. Examples of the nonaqueous electrolyte include a nonaqueous electrolyte prepared by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts, or to use two or more kinds of the above lithium salts in combination.

Examples of the organic solvent which is contained in the nonaqueous electrolyte include carbonates, ethers, esters, nitriles, amides, carbamates, and sulfur-containing compounds, and a fluorine-containing organic solvent obtained by introducing a fluorine group into any of these organic solvents. It is possible to use only one kind of the above organic solvents, or to use two or more kinds of the above organic solvents in combination.

<Method of Producing Nonaqueous Electrolyte Secondary Battery Member and Method of Producing Nonaqueous Electrolyte Secondary Battery>

A nonaqueous electrolyte secondary battery member in accordance with an embodiment of the present invention can be produced by, for example, providing a positive electrode, a nonaqueous electrolyte secondary battery separator in accordance with an embodiment of the present invention or a nonaqueous electrolyte secondary battery laminated separator in accordance with an embodiment of the present invention, and a negative electrode in this order.

A nonaqueous electrolyte secondary battery in accordance with an embodiment of the present invention can be produced by, for example, (i) forming a nonaqueous electrolyte secondary battery member by the above-described method, (ii) placing the nonaqueous electrolyte secondary battery member in a container which is to serve as a housing of the nonaqueous electrolyte secondary battery, (iii) filling the container with a nonaqueous electrolyte, and then (iv) hermetically sealing the container under reduced pressure.

### EXAMPLES

The following description will more specifically discuss the present invention with reference to Examples and Comparative Examples. Note, however, that the present invention is not limited to the Examples.

[Method of Measuring Internal Fractal Dimension]

Respective internal fractal dimensions of the nonaqueous electrolyte secondary battery separators (polyolefin porous films) produced in Examples 1 through 4 and Comparative Examples 1 and 2 were calculated by the following method.

First, a polyolefin porous film was impregnated with an embedding resin (e.g., epoxy resin), the embedding resin filled a void part of the polyolefin porous film and then was cured, and the cured embedding resin was treated with osmium tetroxide, so that a measurement sample was produced. On a surface of the measurement sample, Pt—Pd was vapor-deposited.

It was assumed that a thickness direction of the measurement sample (a direction in which a thickness of the measurement sample extends) is a Z direction, any direction that is parallel to a surface of the measurement sample which surface is orthogonal to the thickness is an X direction, and a direction that is orthogonal to each of the X direction and the Z direction is a Y direction. In this case, a cross section defined by any side X of a surface of the measurement sample and a thickness Z of the measurement sample (hereinafter referred to as an “X-Z cross section”) was produced by carrying out FIB processing with respect to the measurement sample by use of an FIB-SEM (HELIOS600 manufactured by FEI). The cross section was subjected to SEM observation (in which a reflection electron image is shown) at an acceleration voltage of 2.1 kV and a magnification of 6500 times, so that an SEM image was obtained.

After the SEM observation, FIB processing was carried out with respect to the measurement sample by a thickness of 19.2 nm in the Y direction, which is orthogonal to the X-Z cross section, so that a new X-Z cross section was produced. The new X-Z cross section was subjected to the SEM observation (in which a reflection electron image is shown) under the above conditions, so that an SEM image was obtained. Thereafter, FIB processing and SEM image obtainment were similarly repeated at intervals of a thickness of 19.2 nm, so that an X-Z cross section continuous image of the measurement sample was obtained.

Subsequently, the X-Z cross section continuous image was positionally corrected by use of image analysis software (Avizo Ver.6.0 manufactured by Visualization Sciences Group), and the X-Z cross section continuous image thus corrected was obtained on a scale of 19.2 nm/pix in X, Y, and Z-axes.

Quantitative analysis software (TRI/3D-BON-FCS manufactured by Ratoc System Engineering Co., Ltd.) was used to show the X-Z cross section continuous image, which had been positionally corrected, at two gray levels so that a resin part and a void part of the polyolefin porous film could be distinguished.

Specifically, the X-Z cross section continuous image was shown at two gray levels as below. First, the X-Z cross section continuous image was viewed by use of the TRI/3D-BON-FCS. Then, a median filter was used to remove noise from the X-Z cross section continuous image. Subsequently, the X-Z cross section continuous image was shown at two gray levels by use of Auto-LW, so that the resin part and the void part (embedding resin part) were distinguished. The X-Z cross section continuous image was thus shown at two gray levels.

Subsequently, an X-Z plane of the X-Z cross section continuous image in which the resin part and the void part were shown at respective two gray levels was transformed to an X-Y plane by use of SectionView in an EditViewer mode on the TRI/3D-BON-FCS. This allowed the X-Z cross section continuous image to be transformed to a surface direction continuous image (hereinafter referred to as an “X-Y plane continuous image”) of the measurement sample which surface direction continuous image is formed so as to extend from a surface to an inside, i.e., from the surface through the inside to a surface opposite to that surface, of the measurement sample in a thickness direction of the measurement sample, and which surface direction continuous image is shown at two gray levels. The X-Y plane continuous image to which the X-Z cross section continuous image had been transformed was also obtained on a scale of 19.2 nm/pix in X, Y, and Z-axes.

Thereafter, any part whose number of pixels is 256 pix in the X direction, is 256 pix in the Y direction, and corresponds to a thickness pix of the measurement sample in the Z direction was trimmed from the X-Y plane continuous image, so that an analysis continuous image was obtained.

The analysis continuous image was segmented into a plurality of images each having a size of 1 pix in the Z direction. Each of the plurality of images was stored in a form of a monochrome image in bitmap format and then subjected to fractal dimension analysis carried out by a box counting method, so that a fractal dimension of a structure of an interface between the void part and the resin part in each of the plurality of images obtained by the segmentation was calculated. Further, respective fractal dimensions thus calculated in the plurality of images each having a size of 1 pix in the Z direction were averaged, so that an average obtained was referred to as an “internal fractal dimension” of the polyolefin porous film.

[Measurement of Air Permeability]

The polyolefin porous films produced in Examples 1 through 4 and Comparative Examples 1 and 2 were used to measure their respective air permeabilities in conformity with JIS P8117.

[Measurement of Initial Battery Resistance Characteristic]

Respective initial battery resistance characteristics of the nonaqueous electrolyte secondary batteries produced in Examples 1 through 4 (described later) and Comparative Examples 1 and 2 (described later) were measured by the following method.

Each of the nonaqueous electrolyte secondary batteries which had not been subjected to charge and discharge was subjected to four cycles of initial charge and discharge. Each of the four cycles of the initial charge and discharge was carried out at (i) 25° C., (ii) a voltage ranging from 4.1 V to 2.7 V, and (iii) an electric current of 0.2 C (Note that 1 C is defined as an electric current at which a rated capacity based on a discharge capacity at 1 hour rate is discharged for 1 hour. Same applies to the following description).

After the above initial charge and discharge test, by use of an LCR meter (trade name: CHEMICAL IMPEDANCE METER (model: 3532-80)) manufactured by HIOKI E.E. CORPORATION, a voltage having an amplitude of 10 mV was applied, at a room temperature of 25° C., to a nonaqueous electrolyte secondary battery, and a Nyquist plot was calculated. Then, a resistance value R_{10 Hz} of a real part of a measured frequency of 10 Hz was read from the Nyquist plot, and the resistance value R_{10 Hz} thus read was evaluated as a resistance value after the initial charge and discharge test. This resistance value was assumed to be a value of the initial battery resistance characteristic.

### Example 1

[Production of Polyolefin Porous Film]

Example 1 prepared (i) 18% by weight of an ultra-high molecular weight polyethylene powder (HI-ZEX MILLION 145M manufactured by Mitsui Chemicals, Inc.) and (ii) 2% by weight of an alicyclic saturated hydrocarbon resin having a melting point of 131° C. The ultra-high molecular weight polyethylene powder and a powder of the alicyclic saturated hydrocarbon resin were fracture-mixed by use of a blender until these powders had an identical particle size. Thereafter, a resultant mixture of the powders was fed through a quantitative feeder into a twin screw kneading extruder so as to be melted and kneaded at a temperature of 210° C. and a screw speed of 200 rpm. While the mixture was being melted and kneaded, 80% by weight of liquid paraffin was fed into the twin screw kneading extruder with a pump under pressure. Then, the mixture and the liquid paraffin were melted and kneaded together. In an outlet part of the twin screw kneading extruder, the resin had a temperature of 240° C.

Thereafter, a resultant product was extruded through a T-die after having passed through a gear pump, so that a polyolefin resin composition was produced. The polyolefin resin composition was cooled by use of a cooling roller at 40° C., so that a roll of a sheet polyolefin resin composition was obtained.

The obtained sheet polyolefin resin composition was stretched at 117° C. in an MD direction 6.4 times. Subsequently, the sheet polyolefin resin composition was stretched at 115° C. in a TD direction 6.0 times.

The sheet polyolefin resin composition thus stretched was impregnated with heptane, so that an additive was removed therefrom. The sheet polyolefin resin composition was dried at a room temperature while being left still standing, and was further heat-dried by use of a ventilation oven, so that a polyolefin porous film having a thickness of 20.2 μm and an air permeability of 111 sec/100 mL was obtained. The polyolefin porous film is referred to as a polyolefin porous film 1.

[Production of Nonaqueous Electrolyte Secondary Battery]

Next, a nonaqueous electrolyte secondary battery was produced by the following method by using, as a nonaqueous electrolyte secondary battery separator, the polyolefin porous film 1 produced as described earlier.

(Production of Positive Electrode)

A commercially-available positive electrode produced by applying LiNi_{0.5}Mn_{0.3}Co_{0.2}O₂/electrically conductive agent/PVDF (weight ratio 92/5/3) to aluminum foil was used to produce the nonaqueous electrolyte secondary battery. The aluminum foil was cut out of the commercially-available positive electrode so as to have (i) a first part provided with a positive electrode active material layer and having a size of 45 mm×30 mm and (ii) a second part remaining around the first part while being provided with no positive electrode active material layer and having a width of 13 mm. A positive electrode thus obtained was used to produce the nonaqueous electrolyte secondary battery. The positive electrode active material layer had a thickness of 58 μm, a density of 2.50 g/cm³, and a positive electrode capacity of 174 mAh/g.

(Production of Negative Electrode)

A commercially-available negative electrode produced by applying graphite/styrene-1,3-butadiene copolymer/sodium carboxymethyl cellulose (weight ratio 98/1/1) to copper foil was used to produce the nonaqueous electrolyte secondary battery. The copper foil was cut out of the commercially-available negative electrode so as to have (i) a first part provided with a negative electrode active material layer and having a size of 50 mm×35 mm and (ii) a second part remaining around the first part while being provided with no negative electrode active material layer and having a width of 13 mm. A negative electrode thus obtained was used to produce the nonaqueous electrolyte secondary battery. The negative electrode active material layer had a thickness of 49 μm, a density of 1.40 g/cm³, and a negative electrode capacity of 372 mAh/g.

(Assembly of Nonaqueous Electrolyte Secondary Battery)

A nonaqueous electrolyte secondary battery was produced by the following method by use of the positive electrode, the negative electrode, and the polyolefin porous film 1.

A nonaqueous electrolyte secondary battery member was obtained by disposing (providing), in a laminate pouch, the positive electrode, the polyolefin porous film 1 serving as a nonaqueous electrolyte secondary battery separator, and the negative electrode in this order. In this case, the positive electrode and the negative electrode were provided so that a whole of a main surface of the positive electrode active material layer of the positive electrode was included in a range of a main surface (overlapped the main surface) of the negative electrode active material layer of the negative electrode.

Subsequently, the nonaqueous electrolyte secondary battery member was put in a bag including an aluminum layer and a heat seal layer disposed on the aluminum layer, and 0.25 mL of a nonaqueous electrolyte was further poured into the bag. The nonaqueous electrolyte was an electrolyte at 25° C. prepared by dissolving LiPF₆ in a mixed solvent of ethyl methyl carbonate, diethyl carbonate, and ethylene carbonate in a volume ratio of 50:20:30 so that the concentration of LiPF₆ in the electrolyte was 1.0 mole per liter. The bag was heat-sealed while a pressure inside the bag was reduced, so that a nonaqueous electrolyte secondary battery was produced. The nonaqueous electrolyte secondary battery had a design capacity of 20.5 mAh. The nonaqueous electrolyte secondary battery is referred to as a nonaqueous electrolyte secondary battery 1.

### Example 2

[Production of Polyolefin Porous Film]

Example 2 prepared (i) 18% by weight of an ultra-high molecular weight polyethylene powder (HI-ZEX MILLION 145M manufactured by Mitsui Chemicals, Inc.) and (ii) 2% by weight of an alicyclic saturated hydrocarbon resin having a melting point of 156° C. and a softening point of 115° C. The ultra-high molecular weight polyethylene powder and a powder of the alicyclic saturated hydrocarbon resin were fracture-mixed by use of a blender until these powders had an identical particle size. Thereafter, a resultant mixture of the powders was fed through a quantitative feeder into a twin screw kneading extruder so as to be melted and kneaded at a temperature of 210° C. and a screw speed of 200 rpm. While the mixture was being melted and kneaded, 80% by weight of liquid paraffin was fed into the twin screw kneading extruder with a pump under pressure. Then, the mixture and the liquid paraffin were melted and kneaded together. In an outlet part of the twin screw kneading extruder, the resin had a temperature of 238° C.

Thereafter, a resultant product was extruded through a T-die after having passed through a gear pump, so that a polyolefin resin composition was produced. The polyolefin resin composition was cooled by use of a cooling roller at 40° C., so that a roll of a sheet polyolefin resin composition was obtained.

The obtained sheet polyolefin resin composition was stretched at 117° C. in an MD direction 6.4 times. Subsequently, the sheet polyolefin resin composition was stretched at 115° C. in a TD direction 6.0 times.

The sheet polyolefin resin composition thus stretched was impregnated with heptane, so that an additive was removed therefrom. The sheet polyolefin resin composition was dried at a room temperature while being left still standing, and was further heat-dried by use of a ventilation oven, so that a polyolefin porous film having a thickness of 19.7 μm and an air permeability of 115 sec/100 mL was obtained. The polyolefin porous film is referred to as a polyolefin porous film 2.

[Production of Nonaqueous Electrolyte Secondary Battery]

Example 2 produced a nonaqueous electrolyte secondary battery as in the case of Example 1 except that Example 2 used the polyolefin porous film 2 instead of the polyolefin porous film 1. The nonaqueous electrolyte secondary battery thus produced is referred to as a nonaqueous electrolyte secondary battery 2.

### Example 3

[Production of Polyolefin Porous Film]

Example 3 prepared (i) 18% by weight of an ultra-high molecular weight polyethylene powder (HI-ZEX MILLION 145M manufactured by Mitsui Chemicals, Inc.) and (ii) 2% by weight of an alicyclic saturated hydrocarbon resin having a melting point of 175° C. and a softening point of 125° C. The ultra-high molecular weight polyethylene powder and a powder of the alicyclic saturated hydrocarbon resin were fracture-mixed by use of a blender until these powders had an identical particle size. Thereafter, a resultant mixture of the powders was fed through a quantitative feeder into a twin screw kneading extruder so as to be melted and kneaded at a temperature of 210° C. and a screw speed of 200 rpm. While the mixture was being melted and kneaded, 80% by weight of liquid paraffin was fed into the twin screw kneading extruder with a pump under pressure. Then, the mixture and the liquid paraffin were melted and kneaded together. In an outlet part of the twin screw kneading extruder, the resin had a temperature of 238° C.

Thereafter, a resultant product was extruded through a T-die after having passed through a gear pump, so that a polyolefin resin composition was produced. The polyolefin resin composition was cooled by use of a cooling roller at 40° C., so that a roll of a sheet polyolefin resin composition was obtained.

The obtained sheet polyolefin resin composition was stretched at 117° C. in an MD direction 6.4 times. Subsequently, the sheet polyolefin resin composition was stretched at 115° C. in a TD direction 6.0 times.

The sheet polyolefin resin composition thus stretched was impregnated with heptane, so that an additive was removed therefrom. The sheet polyolefin resin composition was dried at a room temperature while being left still standing, and was further heat-dried by use of a ventilation oven, so that a polyolefin porous film having a thickness of 24.2 μm and an air permeability of 179 sec/100 mL was obtained. The polyolefin porous film is referred to as a polyolefin porous film 3.

[Production of Nonaqueous Electrolyte Secondary Battery]

Example 3 produced a nonaqueous electrolyte secondary battery as in the case of Example 1 except that Example 3 used the polyolefin porous film 3 instead of the polyolefin porous film 1. The nonaqueous electrolyte secondary battery thus produced is referred to as a nonaqueous electrolyte secondary battery 3.

### Example 4

[Production of Polyolefin Porous Film]

Example 4 prepared (i) 18% by weight of an ultra-high molecular weight polyethylene powder (HI-ZEX MILLION 145M manufactured by Mitsui Chemicals, Inc.) and (ii) 2% by weight of an alicyclic saturated hydrocarbon resin having a melting point of 131° C. and a softening point of 90° C. The ultra-high molecular weight polyethylene powder and a powder of the alicyclic saturated hydrocarbon resin were fracture-mixed by use of a blender until these powders had an identical particle size. Thereafter, a resultant mixture of the powders was fed through a quantitative feeder into a twin screw kneading extruder so as to be melted and kneaded at a temperature of 210° C. and a screw speed of 200 rpm. While the mixture was being melted and kneaded, 80% by weight of liquid paraffin was fed into the twin screw kneading extruder with a pump under pressure. Then, the mixture and the liquid paraffin were melted and kneaded together. In an outlet part of the twin screw kneading extruder, the resin had a temperature of 240° C.

Thereafter, a resultant product was extruded through a T-die after having passed through a gear pump, so that a polyolefin resin composition was produced. The polyolefin resin composition was cooled by use of a cooling roller at 40° C., so that a roll of a sheet polyolefin resin composition was obtained.

The obtained sheet polyolefin resin composition was stretched at 117° C. in an MD direction 6.4 times. Subsequently, the sheet polyolefin resin composition was stretched at 115° C. in a TD direction 6.0 times.

The sheet polyolefin resin composition thus stretched was impregnated with heptane, so that an additive was removed therefrom. The sheet polyolefin resin composition was dried at a room temperature while being left still standing, and was further heat-dried by use of a ventilation oven, so that a polyolefin porous film having a thickness of 10.0 μm and an air permeability of 137 sec/100 mL was obtained. The polyolefin porous film is referred to as a polyolefin porous film 4.

### [Production of Nonaqueous Electrolyte Secondary Battery]

Example 4 produced a nonaqueous electrolyte secondary battery as in the case of Example 1 except that Example 4 used the polyolefin porous film 4 instead of the polyolefin porous film 1. The nonaqueous electrolyte secondary battery thus produced is referred to as a nonaqueous electrolyte secondary battery 4.

### Comparative Example 1

Comparative 1 prepared (i) 71% by weight of an ultra-high molecular weight polyethylene powder (GUR4032, manufactured by Ticona) and (ii) 29% by weight of polyethylene wax (FNP-0115, manufactured by Nippon Seiro Co., Ltd.) having a weight-average molecular weight of 1,000. To 100 parts by weight, in total, of the ultra-high molecular weight polyethylene powder and the polyethylene wax, 0.4 parts by weight of an antioxidant (Irg1010, manufactured by Ciba Specialty Chemicals Inc.), 0.1 parts by weight of an antioxidant (P168, manufactured by Ciba Specialty Chemicals Inc.), and 1.3 parts by weight of sodium stearate were added. Further, calcium carbonate (manufactured by Maruo Calcium Co., Ltd.) having an average particle size of 0.1 μm was added so that the calcium carbonate accounted for 37% by volume of a total volume of a resultant mixture. The resultant mixture was mixed in a state of powder by use of a Henschel mixer, and then melted and kneaded by use of a twin screw kneading extruder, so that a polyolefin resin composition was obtained. The polyolefin resin composition was rolled by use of a pair of rollers, each having a surface temperature of 150° C., so that a sheet was produced. This sheet was impregnated with an aqueous hydrochloric acid solution (4 mol/L hydrochloric acid, 0.5% by weight of a nonionic surfactant), so that the calcium carbonate was removed from the sheet. Subsequently, the sheet was stretched at 100° C. to 105° C. 6.2 times, so that a film having a thickness of 19.7 μm and an air permeability of 65 sec/100 mL was obtained. The film was further heat-fixed at 110° C., so that a polyolefin porous film was produced. The polyolefin porous film is referred to as a polyolefin porous film 5.

[Production of Nonaqueous Electrolyte Secondary Battery]

Comparative Example 1 produced a nonaqueous electrolyte secondary battery as in the case of Example 1 except that Comparative Example 1 used the polyolefin porous film 5 instead of the polyolefin porous film 1. The nonaqueous electrolyte secondary battery thus produced is referred to as a nonaqueous electrolyte secondary battery 5.

### Comparative Example 2

[Production of Polyolefin Porous Film]

Comparative Example 2 prepared 20% by weight of an ultra-high molecular weight polyethylene powder (HI-ZEX MILLION 145M manufactured by Mitsui Chemicals, Inc.). The prepared ultra-high molecular weight polyethylene powder was fed through a quantitative feeder into a twin screw kneading extruder so as to be melted and kneaded at a temperature of 210° C. and a screw speed of 200 rpm. While the ultra-high molecular weight polyethylene powder was being melted and kneaded, 80% by weight of liquid paraffin was fed into the twin screw kneading extruder with a pump under pressure. Then, the ultra-high molecular weight polyethylene powder and the liquid paraffin were melted and kneaded together. In an outlet part of the twin screw kneading extruder, the resin had a temperature of 245° C.

Thereafter, a resultant product was extruded through a T-die after having passed through a gear pump, so that a polyolefin resin composition was produced. The polyolefin resin composition was cooled by use of a cooling roller at 40° C., so that a roll of a sheet polyolefin resin composition was obtained.

The obtained sheet polyolefin resin composition was stretched at 117° C. in an MD direction 6.4 times. Subsequently, the sheet polyolefin resin composition was stretched at 115° C. in a TD direction 6.0 times.

The sheet polyolefin resin composition thus stretched was impregnated with heptane, so that an additive was removed therefrom. The sheet polyolefin resin composition was dried at a room temperature while being left still standing, and was further heat-dried by use of a ventilation oven, so that a polyolefin porous film having a thickness of 11.9 μm and an air permeability of 436 sec/100 mL was obtained. The polyolefin porous film is referred to as a polyolefin porous film 6.

[Production of Nonaqueous Electrolyte Secondary Battery]

Comparative Example 2 produced a nonaqueous electrolyte secondary battery as in the case of Example 1 except that Comparative Example 2 used the polyolefin porous film 6 instead of the polyolefin porous film 1. The nonaqueous electrolyte secondary battery thus produced is referred to as a nonaqueous electrolyte secondary battery 6.

[Measurement and Evaluation]

The following Table 1 shows respective internal fractal dimensions of the polyolefin porous films 1 through 6 produced in Examples 1 through 4 and Comparative Examples 1 and 2, and values of respective initial battery resistance characteristics of the nonaqueous electrolyte secondary batteries 1 through 6 produced in Examples 1 through 4 and Comparative Examples 1 and 2.

TABLE 1

| | Internal fractal | Initial battery resistance |
|---|---|---|
| | dimension | characteristic [Ω] |
| Example 1 | 1.804 | 0.77 |
| Example 2 | 1.813 | 0.71 |
| Example 3 | 1.882 | 0.73 |
| Example 4 | 1.860 | 0.8 |
| Comparative | 1.747 | 0.91 |
| Example 1 | | |
| Comparative | 1.911 | 1.4 |
| Example 2 | | |

Table 1 reveals that the nonaqueous electrolyte secondary batteries including, as nonaqueous electrolyte secondary battery separators, the respective polyolefin porous films produced in Examples 1 through 4 and each having an internal fractal dimension falling within a range of 1.75 to 1.91 were lower in value of an initial battery resistance characteristic than the nonaqueous electrolyte secondary batteries including, as nonaqueous electrolyte secondary battery separators, the respective polyolefin porous films produced in Comparative Examples 1 and 2 and each having an internal fractal dimension outside the range of 1.75 to 1.91.

That is, it is revealed that the nonaqueous electrolyte secondary batteries including the nonaqueous electrolyte secondary battery separators including the respective polyolefin porous films produced in Examples 1 through 4 are excellent in initial battery resistance characteristic.

### INDUSTRIAL APPLICABILITY

As described earlier, a nonaqueous electrolyte secondary battery separator including a nonaqueous electrolyte secondary battery separator including a polyolefin porous film in accordance with an embodiment of the present invention is excellent in initial battery resistance characteristic. Thus, a polyolefin porous film in accordance with an embodiment of the present invention can be practically used as a base material film of each of a nonaqueous electrolyte secondary battery separator and a nonaqueous electrolyte secondary battery laminated separator.

1. A nonaqueous electrolyte secondary battery separator comprising: a polyolefin porous film,
the polyolefin porous film having an internal fractal dimension of 1.75 to 1.91, the internal fractal dimension being measured, by a box counting method, in accordance with a continuous image of the polyolefin porous film which continuous image is obtained by FIB-SEM measurement at a magnification of 6500 times and by image analysis, in which continuous image the polyolefin porous film has (i) a size of 256 pix×256 pix in a surface direction thereof and (ii) a thickness corresponding to a thickness of the polyolefin porous film, where 1 pix is 19.2 nm, which continuous image is formed so as to extend from a surface of the polyolefin porous film in an internal thickness direction of the polyolefin porous film, and in which continuous image a void part and a resin part of the polyolefin porous film are shown at respective two gray levels.

2. The nonaqueous electrolyte secondary battery separator as set forth in claim 1, wherein the internal fractal dimension is 1.77 to 1.90.

3. A nonaqueous electrolyte secondary battery laminated separator comprising: a nonaqueous electrolyte secondary battery separator recited in claim 1; and an insulating porous layer.

4. A nonaqueous electrolyte secondary battery member comprising: a positive electrode; a nonaqueous electrolyte secondary battery separator recited in claim 1; and a negative electrode, the positive electrode, the nonaqueous electrolyte secondary battery separator, and the negative electrode being provided in this order.

5. A nonaqueous electrolyte secondary battery comprising: a nonaqueous electrolyte secondary battery separator recited in claim 1.

6. A nonaqueous electrolyte secondary battery member comprising: a positive electrode; a nonaqueous electrolyte secondary battery laminated separator recited in claim 3; and a negative electrode, the positive electrode, the nonaqueous electrolyte secondary battery laminated separator, and the negative electrode being provided in this order.

7. A nonaqueous electrolyte secondary battery comprising: a nonaqueous electrolyte secondary battery laminated separator recited in claim 3.
